(19) United States
(12) Patent Application Publication
(10) Pub. No.: US 2026/0340611 A1
(43) Pub. Date: Oct. 29, 2026

(54) RETAIL TRANSACTION SYSTEM

(71) Applicant: Toshiba Global Commerce Solutions, Inc., Durham, NC (US)

(72) Inventors: Yevgeni Tsirulnik, Frisco, TX (US); Yeshai Bouskila, Plano, TX (US); Evgeny Shevtsov, Plano, TX (US); Andrei Khaitas, McKinney, TX (US); James Frank, Montreal (CA)

(73) Assignee: Toshiba Global Commerce Solutions, Inc., Durham, NC (US)

(21) Appl. No.: 19/349,462

(22) Filed: Oct. 3, 2025

Related U.S. Application Data
(60) Provisional application No. 63/702,836, filed on Oct. 3, 2024.

(51) Int. Cl. G06Q 20/20; G06V 20/52; G06V 40/20

(52) U.S. Cl. CPC G06Q 20/20; G06V 20/52; G06V 40/20

(57) ABSTRACT

Systems and methods of performing retail transactions are provided. In one exemplary embodiment, a network node device is coupled to optical sensor devices positioned about a retail space having a set of checkout stations. Each optical sensor device captures successive image data of a corresponding region. The network node device tracks a shopper traversing the retail space based on the successive image data to obtain shopper track information and is further coupled to a wireless device associated with the shopper. The wireless device executes a store application linked to a user account. The network node device sends a checkout request indication that designates a checkout station assigned to the shopper based on at least one of a shopper trust metric associated with the user account, a number of retail items obtained, a set of retail item types requiring additional interaction during checkout, or the shopper track information.

### CROSS REFERENCE TO RELATED APPLICATIONS

This application claims the benefit of U.S. Prv. App. No. 63/702,836, filed Oct. 3, 2024, which is hereby incorporated by reference as if fully set forth herein.

### BACKGROUND

As an alternative and replacement to the traditional cashier-performed checkout model, the self-service or self-checkout model is having an increased impact on retail success. Beyond these models, more advanced self-serve or self-checkout retail models have been proposed in recent years. For instance, a frictionless store model relies on smartphone-related technologies, video tracking systems, and artificial intelligence to provide a type of self-service and self-checkout customer experience. Compared to the cashier-performed checkout and self-service models, the frictionless store model faces more pronounced challenges including the preciseness of checkout transaction recognition and increased exposure to retail shrinkage.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIG. 1 illustrates one embodiment of a system of performing retail transactions in accordance with various aspects as described herein.

FIG. 2A illustrates one embodiment of a network node device in accordance with various aspects as described herein. FIG. 2B illustrates another embodiment of a network node device 200a in accordance with various aspects as described herein.

FIG. 3A illustrates one embodiment of a wireless device in accordance with various aspects as described herein. FIG. 3B illustrates another embodiment of a network node device in accordance with various aspects as described herein.

FIGS. 4A-1, 4A-2 illustrate one embodiment of a method performed by a network node device of performing retail transactions in accordance with various aspects as described herein. FIG. 4B illustrates another embodiment of a method performed by a network node device of performing retail transactions in accordance with various aspects as described herein.

FIG. 5 illustrates another embodiment of a device such as a wireless device or a network node device in accordance with various aspects as described herein.

### DETAILED DESCRIPTION

For simplicity and illustrative purposes, the present disclosure is described by referring mainly to exemplary embodiments thereof. In the following description, numerous specific details are set forth in order to provide a thorough understanding of the present disclosure.

However, it will be readily apparent to one of ordinary skill in the art that the present disclosure may be practiced without limitation to these specific details.

This disclosure includes exemplary embodiments related to performing retail transactions. For instance, a retail transaction system can provide advantages to both retailers and customers that enable a retailer to capitalize on the established trustworthiness and reliability of its customers to enhance their shopping experience. For trusted customers, the retail transaction system can expedite checkout, enabling trusted customers to benefit from faster, more streamlined checkout processes. Further, the system can reduce wait times at checkout. The system can also enable access to restricted products (e.g., products protected by locked shelves), enabling those customers with exclusive access to high valued or restricted items so as to enhance their shopping experience. In addition, the system can personalize product offers and rewards based on a trust level of its customers, enabling trusted customers to receive tailored promotions and rewards so as to enhance their shopping experience and to incentivize their loyalty. The system can also simplify returns and enhance privacy. This return process can be more straightforward for trusted customers by performing less video surveillance for trusted customers and as such, respecting their privacy due to their proven track record.

For retailers, the retail transaction system can improve security and fraud prevention such as by enhancing security measures to help prevent fraud and reduce losses, which protects the retailer's bottom line. Further, the system can enhance the customer experience by providing a personalized and efficient checkout service to trusted customers, enabling retailers to improve overall customer satisfaction, which can lead to increased loyalty and repeated business. The system can also improve operational efficiency by streamlining various processes from checkout to returns, improving the overall operational flow and reducing costs. In addition, the retail transaction system can gain data-driven insights and market differentiation, enabling retailers to gain valuable insights from the data collected on customer behaviors and transactions, enabling them to tailor their strategies for better market positioning and operational decisions.

In one exemplary embodiment, a retail transaction system can collect and analyze data from various sources throughout the consumer shopping experience, capture video from when a customer enters the store, continue through the customer's shopping experience, and to checkout by the customer such as through a checkout station operated by a cashier, a self-checkout station, or an application-based transaction executed by the customer's smartphone. During this analysis, the system can integrate additional data from loyalty programs, identity verification solutions (e.g., biometrics), and payment security systems. Based on the trust level of the customer or the specifics of the transaction, the system can direct a customer to the most appropriate checkout station such as those stations optimized for speed or equipped with additional security measures. The system can also route a customer based on the size of their shopping cart or basket or the types of products in the shopping cart or basket, guiding the customer to a specific checkout station that best fits the customer's needs.

In another exemplary embodiment, a retail transaction system can control access to a secured area (e.g., locked shelves, gated area) within the retail store, enabling secured access to retail items in the secured area based on a profile or credentials of a customer. The system can also enable access to innovative checkout solutions like vision kiosks or application-based checkout, further enhancing the flexibility and efficiency of the shopping experience.

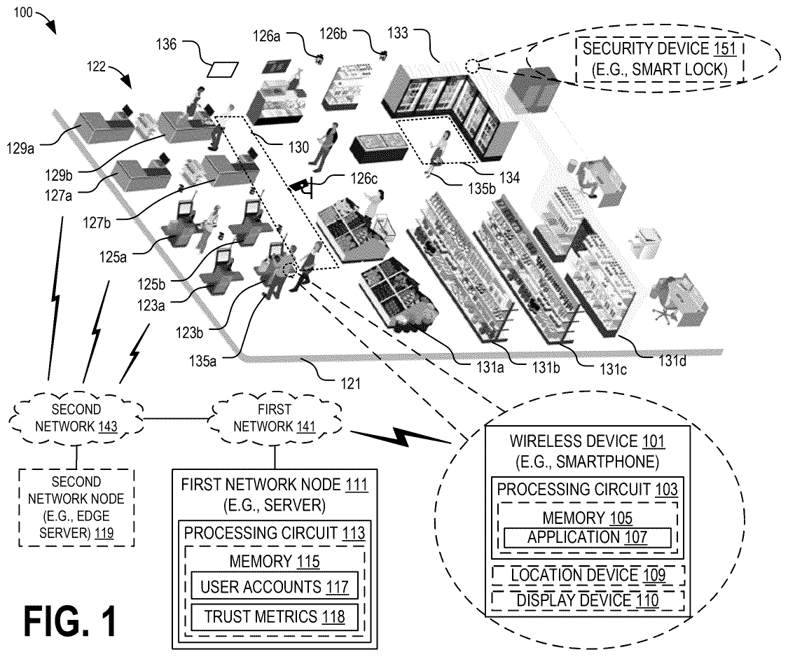

FIG. 1 illustrates one embodiment of a system 100 of performing a retail transaction in a retail store 121 in accordance with various aspect as described herein. In FIG. 1, the system 100 includes a wireless device 101 (e.g., smartphone) operationally coupled to a first network node device 111 (e.g., server) over a first network 141 (e.g., WAN, Internet). The retail store 121 includes a second network node device 119 (e.g., edge server) operationally coupled over a second network 143 (e.g., LAN) to video camera devices 126a-c of a vision tracking system (not shown), a first set of self-checkout stations 123a,b, a second set of self-checkout stations 125a,b, a first set of cashier-performed checkout stations 127a,b, a second set of cashier-performed checkout stations 129a,b, retail item shelves 131a-d having a set of retail items, a secured area 133 (e.g., secured shelves, refrigerator, gated area) having a security device 151 (e.g., smart lock), or the like. The security device 151 can be operable to secure or unsecure the secured area 133. In one example, the security device 151 includes processing circuitry operationally coupled to a security apparatus (e.g., gate, lock). Further, the security device 151 can be operable to secure or unsecure the security apparatus. The first network node 111 can be operationally coupled to the second network node 119 over the first or second network 141, 143. The retail store 121 can be a boutique store, a department store, a supermarket store, a convenience store, a warehouse store, a cashierless store, a frictionless store, or the like. The wireless device 101 can include processing circuitry 103 operable to execute instructions stored in memory 105 such as associated with application 107. The wireless device 101 can also include a location device 109 (e.g., GPS module) operable to determine a current location of the wireless device 101 and a display device 110 (e.g., touchscreen) operable to display an image and detect a touch. The application 107 can be associated with a certain user account of a set of user accounts 117 and a retail store. In addition, the first network node 111 can include processing circuitry 113 operable to execute instructions stored in memory 115 and to store information such as the set of user accounts 117 associated with the application 107 and trust metrics 118 associated with the set of user accounts 117.

In FIG. 1, the second network node 119 can be configured to improve the operational efficiency and customer experience in the retail store environment 121. The second network node 119 can be configured to process data locally within the retail store 121, reducing latency and improving response times for critical applications such as point of sale (POS) systems, inventory management, and customer relationship management (CRM) tools. Further, the second network node 119 can be configured to collect and analyze data from various sensors and devices deployed throughout the store, including IoT devices, entry/exit gate terminals, video devices 126a-c of the vision tracking system, checkout stations 123a,b, 125a,b, 127a-b, 129a,b, and the vision tracking system to enable real-time insights into customer behavior, foot traffic patterns, and inventory levels. The second network node 119 can also be configured to utilize digital signage, promotional displays, and interactive kiosks to engage customers such as delivering multimedia content locally, ensuring smooth playback and reducing dependence on external network bandwidth. In addition, the second network node 119 can be configured to process video feeds provided by the video devices 126a-c, security cameras and surveillance systems to the vision tracking system, perform tasks such as facial recognition, license plate recognition and anomaly detection, and generate alerts for security breaches or suspicious activities in real-time. Additionally, the second network node 119 can be configured to track inventory movements in real-time, update inventory databases, and trigger alerts for low stock levels, enabling timely replenishment and reducing out-of-stock situations. The second network node 119 can also enable personalized customer experiences by analyzing historical and current interactions and transactions so as to recommend products based on past purchases or browsing behavior, enhance cross-selling opportunities, determine trust levels, or the like. The second network node 119 can also operate autonomously to ensure that essential functions such as POS transactions and security monitoring remain uninterrupted.

The vision tracking system of the store 121 can include the video devices 126a-c strategically positioned throughout the store 121 to cover all areas where customers may move in the store 121. Further, the vision tracking system can apply advanced computer vision algorithms to video captured by the video devices 126a-c to detect and track objects such as products and customers in real-time. Such algorithms may include facial recognition or other identification methods to recognize and track individual customers as they move through the store 121, product recognition algorithms to identify and track products to monitor inventory and customer selections, movement tracking algorithms to monitor the movement of customers and products within the store 121, including picking up items, placing them back on shelves, purchasing decisions, or the like. The vision tracking system can also be operationally coupled to the second network node 119 to integrate with store inventory systems and payment systems to track product availability and customer purchases. In addition, the vision tracking system can analyze customer behavior, traffic patterns, popular products, and other data to improve store layout, product placement, and overall customer experience.

Each station 123a,b, 125a,b, 127a,b, 129a,b can be configured to include a scanner device operable to scan a barcode on retail items or can be configured to enable manually entering retail item codes such as on a touchscreen display device. Each station 123a,b, 125a,b, 127a,b, 129a,b can also include a bagging area where clerks or customers can place scanned items. Further, each station 123a,b, 125a,b, 127a,b, 129a,b can verify that all items have been scanned and placed correctly to prevent errors or theft. In addition, each station 123a,b, 125a,b, 127a,b, 129a,b can accept various forms of payment, including credit/debit cards, mobile payment apps, and sometimes cash, can apply coupons or discounts directly at the station 123a,b, 125a,b, 127a,b, 129a,b can print a receipt after completing the transaction, or the like. Each self-checkout station 123a,b, 125a,b can apply security features such as weight sensors to detect unscanned items or unexpected changes in weight during bagging, can provide a user interface to guide customers through each step of the checkout process, or the like. Each cashier-performed checkout station 127a,b, 129a-b can be configured as a checkout lane manned by store personnel such as cashiers. Further, each checkout station 127a,b, 129a,b can be configured to enable customers to bring their items to the cashier, who scans each item using a barcode scanner or manually enters item codes into the system. Cashiers can provide assistance to customers throughout the checkout process, including answering questions about products, handling returns or exchanges, and providing information on store policies. Cashiers can also be responsible for monitoring security, such as checking for age verification on restricted items (e.g., alcohol, tobacco) and ensuring that all items have been properly scanned and paid for.

In FIG. 1, the wireless device 101 can refer to a device capable, configured, arranged and/or operable to communicate wirelessly with the network nodes 111, 119 and/or other devices over the networks 141, 143. Communicating wirelessly may involve transmitting and/or receiving wireless signals using electromagnetic waves, radio waves, infrared waves, and/or other types of signals suitable for conveying information through air. In some embodiments, the wireless device 101 may be configured to transmit and/or receive information without direct human interaction. For instance, the wireless device 101 may be designed to transmit information such as a current location of that wireless device to the first network node 111 on a predetermined schedule, on a periodic bases, when triggered by an internal or external event, or in response to requests from the network. Examples of the wireless device 101 include, but are not limited to, a smartphone, a mobile phone, a cell phone, a voice over IP (VoIP) phone, a wireless local loop phone, a personal digital assistant (PDA), a wireless cameras, a gaming console or device, a music storage device, a playback appliance, a wearable terminal device, a mobile station, a tablet, a laptop, a laptop-embedded equipment (LEE), a laptop-mounted equipment (LME), a smart device, a wireless customer-premise equipment (CPE), or the like.

In one exemplary embodiment, the first network node 111 can obtain data associated with successive images captured by at least one of the set of optical sensor devices 126a-c positioned about the retail space 122 of the retail store 121. For instance, the first network node 111 can receive, from each optical sensor device 126a-c, the successive image data. The first network node 111 can track a shopper 135a,b while that shopper 135a,b traverses about the retail space 122 based on the successive image data to obtain shopper track information. A skilled artisan will readily recognize various techniques for tracking a shopper in a retail space based on a vision tracking system. The first network node 111 can receive, from the wireless device 101 over the network 141, an indication that includes an identifier associated with the certain user account of the set of user accounts 117 of the application 107 and information related to a current location of the wireless device 101. In response, the first network node 111 can associate the tracked shopper 135a,b with the certain user account of the application 107 based on the certain user account identifier, the current location information, the shopper track information, or the successive image data.

Furthermore, the first network node 111 can detect, classify or identify a retail item obtained by the tracked shopper 135a,b while that shopper 135a,b traverses about the retail space 122 based on the shopper track information or the successive image data. Also, the first network node 111 can determine, based on the shopper track information or the successive image data, that the tracked shopper 135a,b is about a certain region 130 of the retail space 122 associated with checkout at the set of checkout stations 123a,b, 125a,b, 127a,b, 129a,b. The first network node 111 can obtain shopper behavior information associated with the certain user account of the application 107. The shopper behavior information can include loyalty program information, identity verification information (e.g., biometric information), payment history information, transaction history information, or the like. In response, the first network node 111 can determine a shopper trust metric associated with the certain user account of the application 107 based on the shopper behavior information. Further, the first network node 111 can determine a number of the obtained retail items obtained by the tracked shopper 135a,b while the tracked shopper 135a,b traverses about the retail space 122 based on the shopper track information or the successive image data. Also, the first network node 111 can determine that the obtained retail item corresponds to at least one of a set of retail item types that requires additional interaction during checkout (e.g., alcohol, tobacco, age restricted, clerk-assisted order items, reserved items, return items, ship-to-home items). The first network node 111 can select at least one of the set of checkout types (e.g., priority checkout, cashier-assisted checkout, self-checkout, mobile shopping) based on the shopper trust metric, the obtained retail item type or the number of obtained retail items, to obtain a selected checkout type.

Moreover, the first network node 111 can assign at least one of the set of checkout stations 123a,b, 125a,b, 127a,b, 129a,b that correspond to the selected checkout type to obtain the assigned checkout station 123a,b, 125a,b, 127a,b, 129a,b. Further, the first network node 111 can determine to send, to the wireless device 101, a request to perform a checkout that utilizes the assigned checkout station 123a,b, 125a,b, 127a,b, 129a,b. In response, the first network node 111 can send, to the wireless device 101 over the network 141, the checkout request indication so that the wireless device 101 is enabled to output for display via the application 107 a visual representation associated with the assigned checkout station 123a,b, 125a,b, 127a,b, 129a,b. Additionally or alternatively, the first network node 111 can send, to an electronic display device 135, the indication that includes the request to perform the checkout utilizing the assigned checkout station 123a,b, 125a,b, 127a,b, 129a,b so that the electronic display device 136 is enabled to output for display a visual representation associated with the assigned checkout station 123a,b, 125a,b, 127a,b, 129a,b that is viewable by the shopper 135a,b while proximate the certain region 130 of the retail space 122 associated with checkout at the set of checkout stations 123a,b, 125a,b, 127a,b, 129a,b. Further, an electronic display device 136 can be positioned so that a shopper proximate the certain region 130 of the retail space 122 associated with checkout at the set of checkout stations 123a,b, 125a,b, 127a,b, 129a,b has a direct field of view to displayed content on the electronic display device 136 such as while that shopper is facing towards the set of checkout stations 123a,b, 125a,b, 127a,b, 129a,b.

In another exemplary embodiment, one or more of the stations 123a,b, 125a,b, 127a,b, 129a,b can be designated as having a priority checkout type such as associated with those shoppers that have a trust metric above a certain trust metric threshold (e.g., at least in the top 50%, 25%, 10%, 5%, 1% of all shoppers), a certain membership with the retail store, a number of obtained retail items that is below a certain threshold (e.g., 3, 5, 10 retail items), or the like.

In another exemplary embodiment, the first network node 111 can determine that the tracked shopper 135a,b is about a certain region 134 that corresponds to the secured area 133 (e.g., secured shelf, secured appliance such as a refrigerator or freezer) in the retail space 122 based on the shopper track information or the successive image data. The first network node 111 can obtain shopper behavior information associated with the certain user account of the application 107. Further, the first network node 111 can determine the shopper trust metric associated with the certain user account of the application 107 based on the shopper behavior information. The first network node 111 can determine to unsecure the secured area 133 based on the shopper trust metric. In response, the first network node 111 can send, to a security device 151 (e.g., lock, gate) associated with the secured area 133, an indication associated with unsecuring the secured area 133 to enable the security device 151 to unsecure the secured area 133. The security device 151 is operable to secure or unsecure the secured area 133. In addition, the first network node 111 can determine that the tracked shopper 135a,b is no longer in the certain region 134 that corresponds to the secured area 133 based on the shopper track information or the successive image data. In response, the first network node 111 can send, to the security device 151 associated with the secured area 133, an indication associated with securing the secured area 133 to enable the security device 151 to secure the secured area 133.

In another exemplary embodiment, the first and second network nodes 111, 119 are the same network node.

In another exemplary embodiment, the first and second networks 141, 143 are the same network.

In another exemplary embodiment, the shopper trust metric can be determined from shopper behavior information that includes loyalty program information, identity verification information, payment history information, transaction history information, or the like. For example, the network node 111 can analyze a shopper's loyalty tier status, such as gold, silver, or bronze levels, with higher tiers reflecting frequent engagement with the retailer and reliable purchasing behavior, thereby contributing to a higher trust metric. The frequency of loyalty program usage, such as consistent points redemption without anomalies, may also positively influence the trust metric. Identity verification information may be considered, including biometric verification such as facial recognition or fingerprint scanning. Successful and consistent authentication events raise the trust metric, whereas failed or inconsistent verifications may lower it. Payment history information can further impact the trust metric, where a history of completed, non-reversed electronic payments across multiple shopping sessions contributes positively, while declined transactions, chargebacks, or use of expired payment instruments reduces the trust metric. Transaction history information may also be analyzed, such as whether current item purchases are consistent with historical shopping patterns. Stability in purchasing behavior raises the trust metric, whereas anomalies, such as high-value purchases when the historical record reflects only small consumable transactions, can lower the trust metric until further verification occurs. In some embodiments, the trust metric can be determined based on a weighted combination of the above factors, such as loyalty program status contributing 40%, biometric verification 20%, payment history 20%, and transaction history 20%. In another embodiment, a rolling average may be applied so that recent positive shopper behaviors weigh more heavily than older data, thereby allowing the trust metric to dynamically reflect the shopper's current trustworthiness.

In another exemplary embodiment, the first network node 111 can select a checkout type from a set of available checkout types, such as priority checkout, cashier-assisted checkout, self-checkout, or mobile shopping, based on the shopper trust metric, the obtained retail item type, or the number of obtained retail items. For instance, if the shopper trust metric is above a defined threshold and only a small number of items have been obtained, the first network node 111 can select a self-checkout type and assign the shopper to one of the available self-checkout stations 125a,b. In another example, if the trust metric is lower or the shopper has a history of failed payment attempts, the network node 111 can select a cashier-assisted checkout type and assign the shopper to a cashier-assisted station 127a,b to ensure human verification. If the shopper has obtained bulky or restricted retail item types, such as alcohol or electronics, the network node 111 can assign the shopper to a cashier-assisted or priority checkout station 123a,b that is configured to handle such transactions. By contrast, if the shopper is a loyalty program member with a high trust metric and is purchasing only a small number of common items, the network node 111 can select a mobile shopping checkout type and assign the shopper to a designated mobile pickup or priority lane 129a,b. In some embodiments, the assignment can be dynamic, such that the first network node 111 evaluates real-time availability of stations within the selected checkout type and routes the shopper to the next available station, thereby ensuring that the assigned checkout station 123a,b, 125a,b, 127a,b, or 129a,b corresponds both to the selected checkout type and to operational capacity of the retail store at the time of checkout.

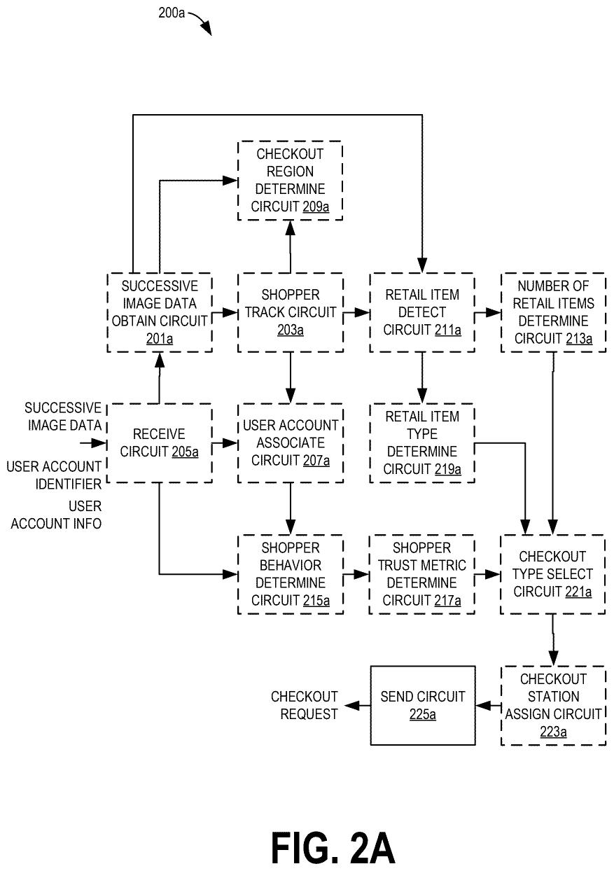

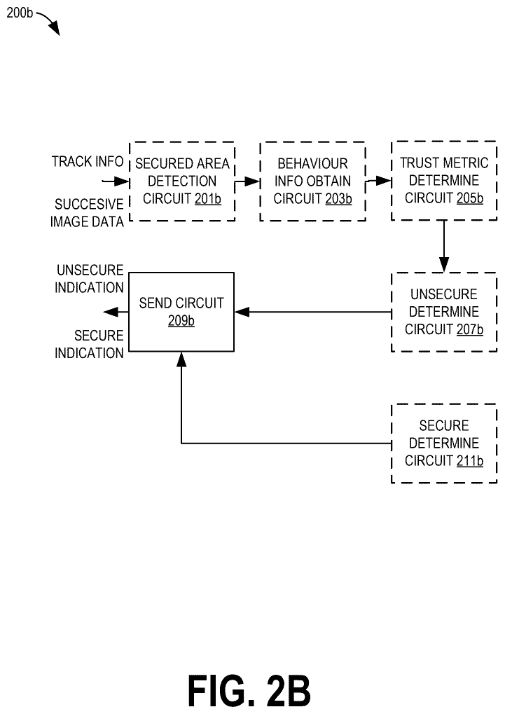

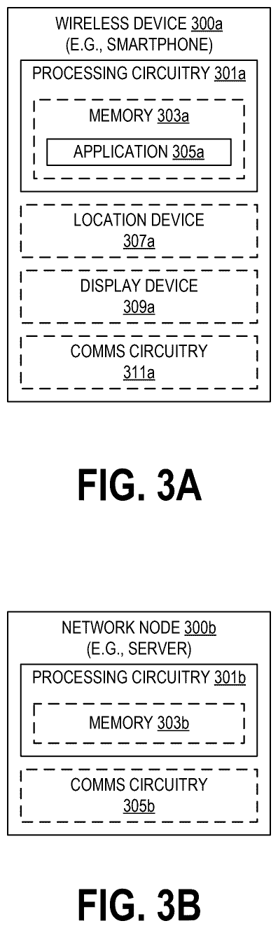

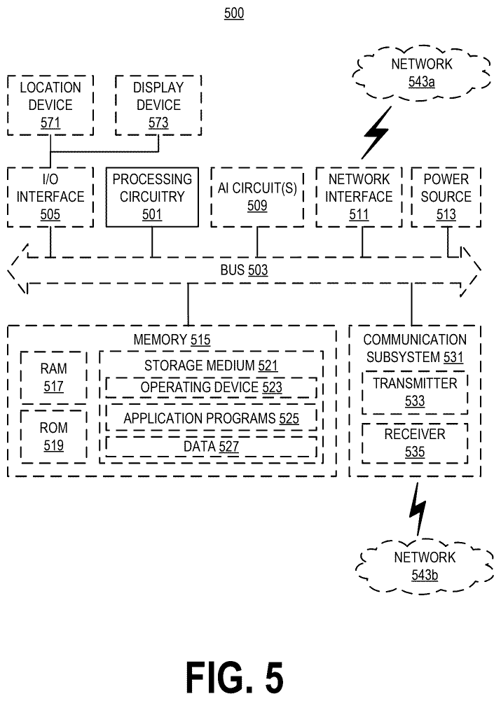

FIG. 2A illustrates one embodiment of a network node device 200a in accordance with various aspects as described herein. In FIG. 2A, the device 200a implements various functional means, units, or modules (e.g., via the processing circuitry 301a in FIG. 3A, via the processing circuitry 501 in FIG. 5, via software code, or the like), or circuits. In one embodiment, these functional means, units, modules, or circuits (e.g., for implementing the method(s) herein) may include for instance: a successive image data obtain circuitry 201a operable to obtain data associated with successive images from at least one of a set of optical sensor devices positioned about a retail space while a shopper traverses about the retail space; a shopper track circuitry 203a operable to track a shopper while the shopper traverses about the retail space based on the successive image data to obtain shopper track information; a receive circuitry 205a operable to receive information; a user account associate circuitry 207a operable to associate the tracked shopper with the certain user account of the application based on the certain user account identifier, the current location information, the shopper track information or the successive image data; a checkout region determination circuitry 209a operable to determine that the tracked shopper is about a certain region of the retail space associated with checkout at the set of checkout stations or a certain region that corresponds to a secured area in the retail space, based on the shopper track information or the successive image data; a retail item detection circuitry 211a operable to detect, classify or identify each retail item obtained by the shopper while the tracked shopper traverses about the retail space based on the shopper track information or the successive image data; a number of retail items determination circuitry 213a operable to determine a number of the obtained retail items obtained while the tracked shopper traverses about the retail space based on the shopper track information or the successive image data; a shopper behavior obtain circuitry 215a operable to obtain shopper behavior information associated with the certain user account; a shopper trust metric determination circuitry 217a operable to determine a shopper trust metric associated with the certain user account based on the shopper behavior information; a retail item type determination circuitry 219a operable to determine that the obtained retail item has at least one of a set of retail item types that requires additional interaction during checkout; a checkout type selection circuitry 221a operable to select at least one of a set of checkout types based on the shopper trust metric, the obtained retail item type or the number of obtained retail items to obtain a selected checkout type; a checkout station assignment circuitry 223a operable to assign at least one of the set of checkout stations that correspond to the selected checkout type to obtain the assigned checkout station; a send circuitry 225a operable to send information; or the like.

FIG. 2B illustrates another embodiment of a network node device 200b in accordance with various aspects as described herein. In FIG. 2B, the device 200b implements various functional means, units, or modules (e.g., via the processing circuitry 301b in FIG. 3B, via the processing circuitry 501 in FIG. 5, via software code, or the like), or circuits. In one embodiment, these functional means, units, modules, or circuits (e.g., for implementing the method(s) herein) may include for instance: a secured area detection circuitry 201b operable to determine that a tracked shopper is about a certain region that corresponds to a secured area in the retail space based on shopper track information or successive image data; a behavior information obtain circuitry 203a operable to obtain shopper behavior information associated with the certain user account; a trust metric determination circuitry 205b operable to determine a shopper trust metric associated with the certain user account based on the shopper behavior information; an unsecure determination circuitry 207b operable to determine to unsecure (e.g., unlock) the secured area based on the shopper trust metric; a send circuitry 209b operable to send information; a secure determination circuitry 211b operable to determine that the tracked shopper is no longer in the certain region that corresponds to the secured area based on the shopper track information or the successive image data; or the like.

FIG. 3A illustrates one embodiment of a wireless device 300a in accordance with various aspects as described herein. As shown, the device 300a includes processing circuitry 301a, a location device 307a, a display device 309a communication circuitry 311a, or the like. The location device 307a (e.g., GPS device) is configured to provide a current location of the wireless device 300a. The display device 309a is configured to display an image. The communication circuitry 311a is configured to transmit and/or receive information to and/or from one or more other nodes (e.g., via any communication technology). The processing circuitry 301a is configured to perform processing described above, such as by executing instructions stored in memory 303a such as associated with application 305a. The processing circuitry 301a in this regard may implement certain functional means, units, or modules.

FIG. 3B illustrates another embodiment of a network node device 300b in accordance with various aspects as described herein. As shown, the device 300b includes processing circuitry 301b and communication circuitry 311b. The communication circuitry 305b is configured to transmit and/or receive information to and/or from one or more other nodes (e.g., via any communication technology). The processing circuitry 301b is configured to perform processing described above, such as by executing instructions stored in memory 303b. The processing circuitry 301a in this regard may implement certain functional means, units, or modules.

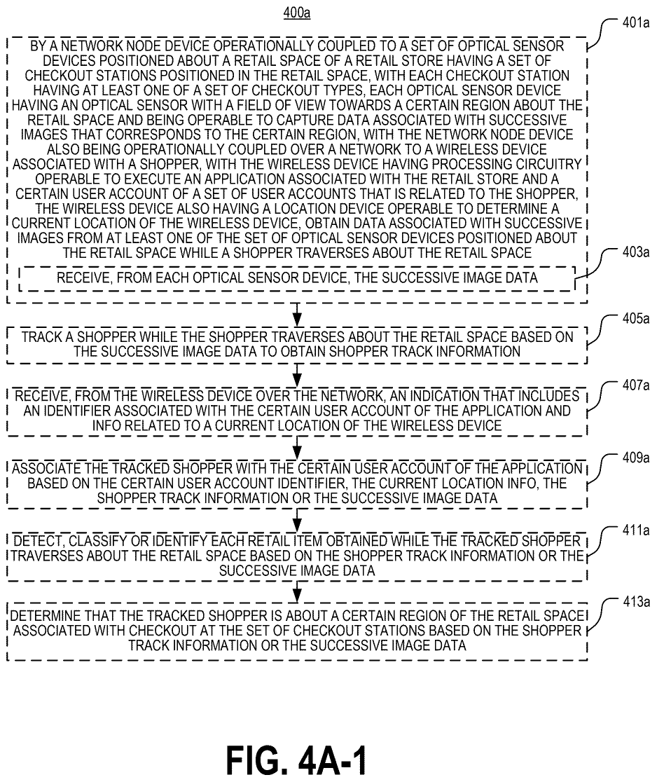

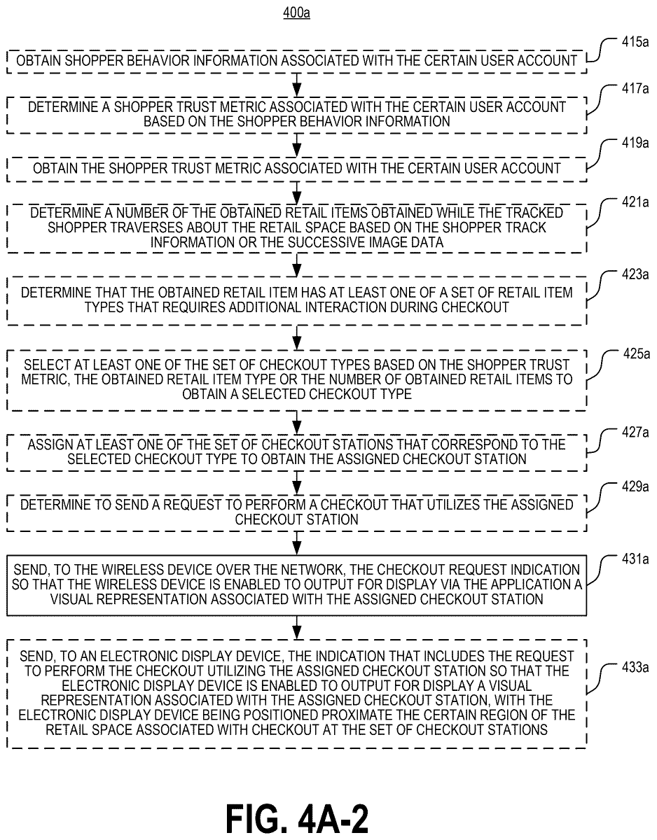

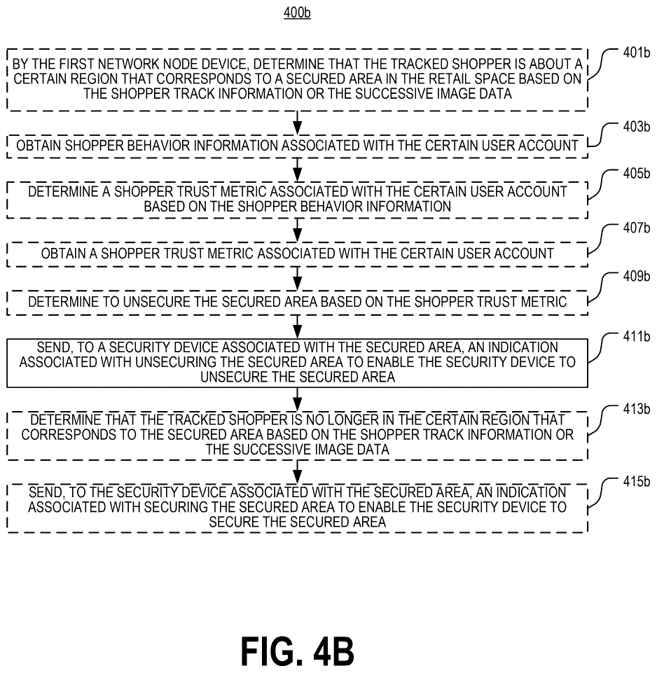

FIGS. 4A-1, 4A-2 illustrate one embodiment of a method 400a performed by a network node device of performing retail transactions in accordance with various aspects as described herein. In FIG. 4A-1, the method 400a may start, for instance, at block 401a where it can include obtaining data associated with successive images from at least one of the set of optical sensor devices positioned about the retail space while a shopper traverses about the retail space. At block 403a, the method 400a can include receiving, from each optical sensor device, the successive image data. At block 405a, the method 400a can include tracking a shopper while the shopper traverses about the retail space based on the successive image data to obtain shopper track information. At block 407a, the method 400a can include receiving, from a wireless device over a network, an indication that includes an identifier associated with the certain user account of the application and information related to a current location of the wireless device. At block 409a, the method 400a can include associating the tracked shopper with the certain user account of the application based on the certain user account identifier, the current location information, the shopper track information or the successive image data. At block 411a, the method 400a can include detecting, classifying or identifying each retail item obtained while the tracked shopper traverses about the retail space based on the shopper track information or the successive image data. At block 413a, the method 400a can include determining that the tracked shopper is about a certain region of the retail space associated with checkout at a set of checkout stations based on the shopper track information or the successive image data.

In FIG. 4A-2, the method 400a can include obtaining shopper behavior information associated with the certain user account, as represented by block 415a. At block 417a, the method 400a can include determining a shopper trust metric associated with the certain user account based on the shopper behavior information. At block 419a, the method 400a can include obtaining the shopper trust metric associated with the certain user account. At block 421a, the method 400a can include determining a number of the obtained retail items obtained while the tracked shopper traverses about the retail space based on the shopper track information or the successive image data. At block 423a, the method 400a can include determining that the obtained retail item has at least one of a set of retail item types that requires additional interaction during checkout. At block 425a, the method 400a can include selecting at least one of the set of checkout types based on the shopper trust metric, the obtained retail item type or the number of obtained retail items to obtain a selected checkout type. At block 427a, the method 400a can include assigning at least one of the set of checkout stations that correspond to the selected checkout type to obtain the assigned checkout station. At block 429a, the method 400a can include determining to send a request to perform a checkout that utilizes the assigned checkout station. At block 431a, the method 400a can include sending, to the wireless device over the network, the checkout request indication so that the wireless device is enabled to output for display via the application a visual representation associated with the assigned checkout station. Additionally or alternatively, the method 400a can include sending, to an electronic display device, the indication that includes the request to perform the checkout utilizing the assigned checkout station so that the electronic display device is enabled to output for display a visual representation associated with the assigned checkout station, with the electronic display device being positioned proximate the certain region of the retail space associated with checkout at the set of checkout stations, as represented by block 433a.

FIG. 4B illustrates another embodiment of a method 400b performed by a network node device of performing retail transactions in accordance with various aspects as described herein. In FIG. 4B, the method 400b may start, for instance, at block 401b where it can include determining that the tracked shopper is about a certain region that corresponds to a secured area in the retail space based on the shopper track information or the successive image data. At block 403b, the method 400b can include obtaining shopper behavior information associated with the certain user account. At block 405b, the method 400b can include determining a shopper trust metric associated with the certain user account based on the shopper behavior information. At block 407b, the method 400b can include obtaining a shopper trust metric associated with the certain user account. At block 409b, the method 400b can include determining to unsecure the secured area based on the shopper trust metric. At block 411b, the method 400b can include sending, to a security device associated with the secured area, an indication associated with a request for the security device to unsecure the secured area. At block 413b, the method 400b can include determining that the tracked shopper is no longer in the certain region that corresponds to the secured area based on the shopper track information or the successive image data. At block 415b, the method 400b can include sending, to the security device associated with the secured area, an indication associated with securing the secured area to enable the security device to secure the secured area

FIG. 5 illustrates another embodiment of a device 500 such as a wireless device or a network node device in accordance with various aspects as described herein. In FIG. 5, device 500 includes processing circuitry 501 that is operatively coupled to input/output interface 505, artificial intelligence circuit 509, network connection interface 511, power source 513, memory 515 including random access memory (RAM) 517, read-only memory (ROM) 519, and storage medium 521 or the like, communication subsystem 531, and/or any other component, or any combination thereof.

The input/output interface 505 may be configured to provide a communication interface to an input device, output device, or input and output device. The device 500 may be configured to use an input/output device via input/output interface 505 such as the location device 571 (e.g., GPS module) and the display device 573 (e.g., touchscreen). An output device may use the same type of interface port as an input device. For example, a USB port may be used to provide input to and output from the device 500. The output device may be a speaker, a sound card, a video card, a display, a monitor, a printer, an actuator, an emitter, a smartcard, another output device, or any combination thereof. The device 500 may be configured to use an input device via input/output interface 505 to allow a user to capture information into the device 500. The input device may include a touch-sensitive or presence-sensitive display, an optical sensor (e.g., a digital camera, a digital video camera, a web camera, etc.), a location device, a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical or image sensor, an infrared sensor, a proximity sensor, another like sensor, or any combination thereof.

In FIG. 5, storage medium 521 may include operating system 523, application program 525, data 527, the like, or any combination thereof. In other embodiments, storage medium 521 may include other similar types of information. Certain devices may utilize all of the components shown in FIG. 5, or only a subset of the components. The level of integration between the components may vary from one device to another device. Further, certain devices may contain multiple instances of a component, such as multiple processors, memories, neural networks, network connection interfaces, transceivers, etc.

In FIG. 5, processing circuitry 501 may be configured to process computer instructions and data. Processing circuitry 501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 501 may include two central processing units (CPUs). Data may be information in a form suitable for use by a computer.

In FIG. 5, the artificial intelligence circuit 509 may be configured to learn to perform tasks by considering examples. For instance, the Al circuit 509 may be operable to detect, classify or identify each retail item obtained while the tracked shopper traverses about the retail space based on the shopper track information or the successive image data. In FIG. 5, the network connection interface 511 may be configured to provide a communication interface to network 543a. The network 543a may encompass wired and/or wireless networks such as a local-area network (LAN), a wide-area network (WAN), a computer network, a wireless network, a telecommunications network, another like network or any combination thereof. For example, network 543a may comprise a Wi-Fi network. The network connection interface 511 may be configured to include a receiver and a transmitter interface used to communicate with one or more other devices over a communication network according to one or more communication protocols, such as Ethernet, TCP/IP, SONET, ATM, or the like. The network connection interface 511 may implement receiver and transmitter functionality appropriate to the communication network links (e.g., optical, electrical, and the like). The transmitter and receiver functions may share circuit components, software or firmware, or alternatively may be implemented separately.

The RAM 517 may be configured to interface via a bus 503 to the processing circuitry 501 to provide storage or caching of data or computer instructions during the execution of software programs such as the operating system, application programs, and device drivers. The ROM 519 may be configured to provide computer instructions or data to processing circuitry 501. For example, the ROM 519 may be configured to store invariant low-level system code or data for basic system functions such as basic input and output (I/O), startup, or reception of keystrokes from a keyboard that are stored in a non-volatile memory. The storage medium 521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, the storage medium 521 may be configured to include an operating system 523, an application program 525 such as web browser, web application, user interface, browser data manager as described herein, a widget or gadget engine, or another application, and a data file 527. The storage medium 521 may store, for use by the device 500, any of a variety of various operating systems or combinations of operating systems.

The storage medium 521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. The storage medium 521 may allow the device 500a-b to access computer-executable instructions, application programs or the like, stored on transitory or non-transitory memory media, to off-load data, or to upload data. An article of manufacture, such as one utilizing a communication system may be tangibly embodied in the storage medium 521, which may comprise a device readable medium.

The processing circuitry 501 may be configured to communicate with network 543b using the communication subsystem 531. The network 543a and the network 543b may be the same network or networks or different network or networks. The communication subsystem 531 may be configured to include one or more transceivers used to communicate with the network 543b. For example, the communication subsystem 531 may be configured to include one or more transceivers used to communicate with one or more remote transceivers of another device capable of wireless communication according to one or more communication protocols, such as IEEE 802.11, CDMA, WCDMA, GSM, LTE, UTRAN, WiMax, or the like. Each transceiver may include transmitter 533 and/or receiver 535 to implement transmitter or receiver functionality, respectively, appropriate to the RAN links (e.g., frequency allocations and the like). Further, transmitter 533 and receiver 535 of each transceiver may share circuit components, software, or firmware, or alternatively may be implemented separately.

In FIG. 5, the communication functions of the communication subsystem 531 may include data communication, voice communication, multimedia communication, short-range communications such as Bluetooth, near-field communication, location-based communication such as the use of the global positioning system (GPS) to determine a location, another like communication function, or any combination thereof. For example, the communication subsystem 531 may include cellular communication, Wi-Fi communication, Bluetooth communication, and GPS communication. The network 543b may encompass wired and/or wireless networks such as a local-area network (LAN), a wide-area network (WAN), a computer network, a wireless network, a telecommunications network, another like network or any combination thereof. For example, the network 543b may be a cellular network, a Wi-Fi network, and/or a near-field network. The power source 513 may be configured to provide alternating current (AC) or direct current (DC) power to components of the device 500a-b.

The features, benefits and/or functions described herein may be implemented in one of the components of the device 500 or partitioned across multiple components of the device 500. Further, the features, benefits, and/or functions described herein may be implemented in any combination of hardware, software, or firmware. In one example, communication subsystem 531 may be configured to include any of the components described herein. Further, the processing circuitry 501 may be configured to communicate with any of such components over the bus 503. In another example, any of such components may be represented by program instructions stored in memory that when executed by the processing circuitry 501 perform the corresponding functions described herein. In another example, the functionality of any of such components may be partitioned between the processing circuitry 501 and the communication subsystem 531. In another example, the non-computationally intensive functions of any of such components may be implemented in software or firmware and the computationally intensive functions may be implemented in hardware.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts for illustrative purposes, but the embodiments are similarly applicable in other contexts not explicitly described.

In one exemplary embodiment, a method is provided in which a network node device is operationally coupled to a set of optical sensor devices positioned about a retail space of a retail store having a set of checkout stations positioned in the retail space, with each checkout station having at least one of a set of checkout types. Each optical sensor device includes an optical sensor with a field of view toward a certain region of the retail space and is operable to capture successive image data that corresponds to the certain region. The network node device is operable to track a shopper as the shopper traverses the retail space based on successive images captured from at least one of the optical sensor devices. The network node device is also coupled over a network to a wireless device associated with the tracked shopper, with the wireless device having processing circuitry operable to execute an application associated with the retail store and having a certain user account of a set of user accounts that is related to the tracked shopper. The method includes sending an indication that comprises a request to perform a checkout utilizing a certain checkout station of the set of checkout stations that is assigned to the tracked shopper based on a shopper trust metric associated with the user account, a number of retail items obtained while the tracked shopper is tracked about the retail space, or a certain retail item type of those obtained retail items.

In another exemplary embodiment, the sending step further includes transmitting, to the wireless device over the network, the checkout request indication so that the wireless device is enabled to output for display via the application a visual representation associated with the assigned checkout station.

In another exemplary embodiment, the sending step further includes transmitting, to an electronic display device, the checkout request indication so that the electronic display device is enabled to output for display a visual representation associated with the assigned checkout station. The electronic display device is positioned proximate to the certain region of the retail space associated with the checkout at the set of checkout stations.

In another exemplary embodiment, the method further includes obtaining data associated with successive images captured from at least one of the optical sensor devices positioned about the retail space.

In another exemplary embodiment, the method further includes receiving, from each optical sensor device, the successive image data.

In another exemplary embodiment, the method further includes tracking the tracked shopper while the shopper traverses the retail space based on the successive image data to obtain shopper track information.

In another exemplary embodiment, the method further includes receiving, from the wireless device over the network, an indication that includes an identifier associated with the certain user account of the application and information related to a current location of the wireless device.

In another exemplary embodiment, the method further includes associating the tracked shopper with the certain user account of the application based on the account identifier, the current location information, the shopper track information, or the successive image data.

In another exemplary embodiment, the method further includes detecting, classifying, or identifying a retail item obtained while the tracked shopper traverses the retail space based on the shopper track information or the successive image data.

In another exemplary embodiment, the method further includes determining, based on the shopper track information or the successive image data, that the tracked shopper is about a certain region of the retail space associated with a checkout at the set of checkout stations.

In another exemplary embodiment, the method further includes obtaining, based on the certain user account of the application, shopper behavior information associated with the user account, or determining the shopper trust metric associated with the user account based on the shopper behavior information.

In another exemplary embodiment, the method further includes obtaining the shopper trust metric associated with the user account of the application, selecting at least one of the set of checkout types based on the shopper trust metric or the obtained retail item to obtain a selected checkout type, assigning at least one of the set of checkout stations that correspond to the selected checkout type to obtain the assigned checkout station, or determining to send a request to perform a checkout that utilizes the assigned checkout station.

In another exemplary embodiment, the sending step further includes transmitting, to the wireless device over the network, an indication that includes the request to perform the checkout utilizing the assigned checkout station so that the wireless device is enabled to output for display via the application a visual representation associated with the assigned checkout station.

In another exemplary embodiment, the sending step further includes transmitting, to an electronic display device operationally coupled to the network node device, the indication that includes the request to perform the checkout utilizing the assigned checkout station so that the electronic display device is enabled to output for display a visual representation associated with the assigned checkout station, with the electronic display device being positioned proximate the certain region of the retail space associated with initiation of checkout at the set of checkout stations.

In another exemplary embodiment, the method further includes determining a number of the obtained retail items obtained while the tracked shopper traverses the retail space based on the shopper track information or the successive image data.

In another exemplary embodiment, the method further includes determining that at least one of the obtained retail items corresponds to a certain retail item type that requires additional interaction during checkout.

In one exemplary embodiment, a network node device is provided, with the network node device being operationally coupled to a set of optical sensor devices positioned about a retail space of a retail store having a set of checkout stations positioned in the retail space, with each checkout station having at least one of a set of checkout types. Each optical sensor device has a field of view toward a certain region of the retail space and is operable to capture successive image data corresponding to the region. The network node device is operable to track a shopper as the shopper traverses the retail space based on successive images captured from at least one of the optical sensor devices. The network node device is also coupled over a network to a wireless device associated with the tracked shopper, with the wireless device having processing circuitry operable to execute an application associated with the retail store and having a certain user account of a set of user accounts that is related to the tracked shopper. The network node device further comprises a memory containing instructions executable by processing circuitry whereby the processing circuitry is configured to send an indication that includes a request to perform a checkout that utilizes a certain checkout station assigned to the tracked shopper based on a shopper trust metric associated with the user account, a number of retail items obtained while the shopper is tracked about the retail space, or a certain retail item type of those obtained retail items.

In one exemplary embodiment, a method is provided in which a network node device is operationally coupled to a set of optical sensor devices positioned about a retail space of a retail store. Each optical sensor device has a field of view toward a certain region of the retail space and is operable to capture successive image data corresponding to that region. The network node device is operable to track a shopper as the shopper traverses the retail space based on successive images captured from at least one of the optical sensor devices. The network node device is also operationally coupled over a network to a wireless device associated with the tracked shopper, with the wireless device having processing circuitry operable to execute an application associated with the retail store and having a certain user account of a set of user accounts that is related to the tracked shopper. The network node device is also operationally coupled to a security device operable to secure or unsecure access to a secured area in the retail space. The method includes sending, to the security device associated with the secured area, an indication associated with unsecuring the secured area to enable the security device to unsecure the secured area based on a shopper trust metric associated with the certain user account and the tracked shopper.

In another exemplary embodiment, the method further includes obtaining data associated with successive images captured from at least one of the optical sensor devices positioned about the retail space.

In another exemplary embodiment, the method further includes receiving, from each optical sensor device, the successive image data.

In another exemplary embodiment, the method further includes tracking the tracked shopper while the shopper traverses the retail space based on the successive image data to obtain shopper track information.

In another exemplary embodiment, the method further includes receiving, from the wireless device over the network, an indication that includes an identifier associated with the user account of the application and information related to a current location of the wireless device, or associating the tracked shopper with the user account based on the account identifier, the current location information, the shopper track information, or the successive image data.

In another exemplary embodiment, the method further includes determining that the tracked shopper is about a certain region that corresponds to the secured area in the retail space based on the shopper track information or the successive image data.

In another exemplary embodiment, the method further includes obtaining, based on the user account of the application, shopper behavior information associated with the account, or determining the shopper trust metric associated with the account based on the shopper behavior information.

In another exemplary embodiment, the method further includes obtaining the shopper trust metric associated with the user account of the application, or determining to unsecure the secured area based on the shopper trust metric.

In another exemplary embodiment, the method further includes transmitting, to the security device associated with the secured area, an indication associated with unsecuring the secured area to enable the security device to unsecure the secured area.

In another exemplary embodiment, the method further includes determining that the tracked shopper is no longer in the certain region that corresponds to the secured area based on the shopper track information or the successive image data.

In another exemplary embodiment, the method further includes sending, to the security device associated with the secured area, an indication associated with securing the secured area to enable the security device to secure the secured area.

In one exemplary embodiment, a network node device is provided, with the network node device being operationally coupled to a set of optical sensor devices positioned about a retail space of a retail store. Each optical sensor device has a field of view toward a certain region of the retail space and is operable to capture successive image data corresponding to the region. The network node device is operable to track a shopper as the shopper traverses the retail space based on successive images captured from at least one of the optical sensor devices. The network node device is also coupled over a network to a wireless device associated with the tracked shopper, with the wireless device having processing circuitry operable to execute an application associated with the retail store and having a certain user account of a set of user accounts that is related to the tracked shopper. The network node device is also operationally coupled to a security device operable to secure or unsecure access to a secured area in the retail space. The network node device further comprises a memory containing instructions executable by the processing circuitry whereby the processing circuitry is configured to send, to the security device associated with the secured area, an indication associated with unsecuring the secured area to enable the security device to unsecure the secured area based on a shopper trust metric associated with the user account and the tracked shopper.

In one exemplary embodiment, a method is provided in which a network node device is operationally coupled to a set of optical sensor devices positioned about a retail space of a retail store having a set of checkout stations positioned in the retail space, with each checkout station having at least one of a set of checkout types. Each optical sensor device includes an optical sensor with a field of view towards a certain region of the retail space and is operable to capture successive image data corresponding to that region. The network node device is operable to track a shopper as the shopper traverses the retail space based on successive images captured from at least one of the optical sensor devices to obtain shopper track information. The network node device is also operationally coupled over a network to a wireless device associated with the tracked shopper, with the wireless device having processing circuitry operable to execute an application associated with the retail store and having a certain user account of a set of user accounts related to the tracked shopper. The method further includes sending a checkout request indication that includes a request to perform a checkout utilizing a certain checkout station of the set of checkout stations, the certain checkout station being assigned to the tracked shopper based on at least one of a shopper trust metric associated with the certain user account, a number of retail items obtained while the tracked shopper is tracked about the retail space, a set of retail item types that requires additional interaction during checkout, or the shopper track information.

In another exemplary embodiment, the sending step further includes transmitting the checkout request indication to the wireless device so that the wireless device is enabled to output for display via the application a visual representation associated with the assigned checkout station.

In another exemplary embodiment, the sending step further includes transmitting the checkout request indication to an electronic display device so that the electronic display device is enabled to output for display a visual representation associated with the assigned checkout station, with the electronic display device being positioned proximate the certain region of the retail space associated with the checkout at the set of checkout stations.

In another exemplary embodiment, the method further comprises receiving, by the network node device, from the wireless device over the network, an indication that includes an identifier associated with the certain user account of the application and information related to a current location of the wireless device.

In another exemplary embodiment, the method further comprises associating the tracked shopper with the certain user account of the application based on at least one of the identifier associated with the certain user account, the current location information, the shopper track information, or the successive image data.

In another exemplary embodiment, the method further comprises determining, based on the shopper track information or the successive image data, that the tracked shopper is about a certain region of the retail space associated with a checkout at the set of checkout stations.

In another exemplary embodiment, the method further comprises obtaining, based on the certain user account of the application, shopper behavior information associated with the certain user account, and determining the shopper trust metric associated with the certain user account based on the shopper behavior information.

In another exemplary embodiment, the method further comprises obtaining the shopper trust metric associated with the certain user account of the application, selecting at least one of the set of checkout types based on the shopper trust metric to obtain a selected checkout type, assigning at least one of the set of checkout stations that correspond to the selected checkout type to obtain the assigned checkout station, and determining to send a request to perform a checkout that utilizes the assigned checkout station.

In another exemplary embodiment, the method further comprises determining a number of the obtained retail items obtained while the tracked shopper traverses the retail space based on at least one of the shopper track information or the successive image data, selecting at least one of the set of checkout types based on the shopper trust metric and the number of the obtained retail items to obtain a selected checkout type, assigning at least one of the set of checkout stations that correspond to the selected checkout type to obtain the assigned checkout station, and determining to send a request to perform a checkout that utilizes the assigned checkout station.

In another exemplary embodiment, the method further comprises determining that at least one of the obtained retail items corresponds to a set of retail item types that requires additional interaction during checkout, selecting at least one of the set of checkout types based on the shopper trust metric and the set of retail item types that requires additional interaction during checkout to obtain a selected checkout type, assigning at least one of the set of checkout stations that correspond to the selected checkout type to obtain the assigned checkout station, and determining to send a request to perform a checkout that utilizes the assigned checkout station.

In one exemplary embodiment, a network node device is provided, with the network node device being operationally coupled to a set of optical sensor devices positioned about a retail space of a retail store having a set of checkout stations positioned in the retail space, each checkout station having at least one of a set of checkout types. Each optical sensor device includes an optical sensor with a field of view toward a certain region of the retail space and is operable to capture successive image data corresponding to that region. The network node device is operable to track a shopper as the shopper traverses the retail space based on successive images captured from at least one of the set of optical sensor devices to obtain shopper track information. The network node device is also operationally coupled over a network to a wireless device associated with the tracked shopper, with the wireless device having processing circuitry operable to execute an application associated with the retail store and having a certain user account of a set of user accounts related to the tracked shopper. The network node device includes processing circuitry and a memory, the memory containing instructions executable by the processing circuitry whereby the processing circuitry is configured to send a checkout request indication that includes a request to perform a checkout that utilizes a certain checkout station of the set of checkout stations assigned to the tracked shopper based on at least one of a shopper trust metric associated with the certain user account, a number of retail items obtained while the tracked shopper is tracked about the retail space, a set of retail item types that requires additional interaction during checkout, or the shopper track information.

In another exemplary embodiment, the network node device is configured to send the checkout request indication to the wireless device so that the wireless device is enabled to output for display via the application a visual representation associated with the assigned checkout station.

In another exemplary embodiment, the network node device is configured to send the checkout request indication to an electronic display device so that the electronic display device is enabled to output for display a visual representation associated with the assigned checkout station, with the electronic display device being positioned proximate the certain region of the retail space associated with the checkout at the set of checkout stations.

In another exemplary embodiment, the network node device is configured to receive, from each of the set of optical sensor devices, the successive image data.

In another exemplary embodiment, the network node device is configured to track the tracked shopper while the shopper traverses the retail space based on the successive image data to obtain the shopper track information.

In another exemplary embodiment, the network node device is configured to receive, from the wireless device, an indication that includes an identifier associated with the certain user account of the application and information related to a current location of the wireless device.

In another exemplary embodiment, the network node device is configured to obtain the shopper trust metric associated with the certain user account of the application, select at least one of the set of checkout types based on the shopper trust metric to obtain a selected checkout type, assign at least one of the set of checkout stations that correspond to the selected checkout type to obtain the assigned checkout station, and determine to send a request to perform a checkout that utilizes the assigned checkout station.

In another exemplary embodiment, the network node device is configured to determine a number of the obtained retail items obtained while the tracked shopper traverses the retail space based on at least one of the shopper track information or the successive image data, select at least one of the set of checkout types based on the shopper trust metric and the number of the obtained retail items to obtain a selected checkout type, assign at least one of the set of checkout stations that correspond to the selected checkout type to obtain the assigned checkout station, and determine to send a request to perform a checkout that utilizes the assigned checkout station.

In another exemplary embodiment, the network node device is configured to determine that at least one of the obtained retail items corresponds to a set of retail item types that requires additional interaction during checkout, select at least one of the set of checkout types based on the shopper trust metric and the set of retail item types that requires additional interaction during checkout to obtain a selected checkout type, assign at least one of the set of checkout stations that correspond to the selected checkout type to obtain the assigned checkout station, and determine to send a request to perform a checkout that utilizes the assigned checkout station.

In one exemplary embodiment, a system is provided that includes a set of checkout stations positioned in a retail space of a retail store, with each checkout station having at least one of a set of checkout types, and a set of optical sensor devices positioned about the retail space, with each optical sensor device having an optical sensor with a field of view toward a certain region of the retail space and being operable to capture successive image data that corresponds to the certain region. The system further includes a network node device operably coupled to the set of optical sensor devices, with the network node device including processing circuitry and a memory containing instructions executable by the processing circuitry whereby the processing circuitry is configured to track a shopper as the shopper traverses the retail space based on successive images captured from at least one of the optical sensor devices to obtain shopper track information, and send a checkout request indication that includes a request to perform a checkout utilizing a certain checkout station of the set of checkout stations that is assigned to the tracked shopper based on at least one of a shopper trust metric associated with a certain user account related to the shopper, a number of retail items obtained while the shopper is tracked about the retail space, a set of retail item types that requires additional interaction during checkout, or the shopper track information.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods, devices and systems described herein. Alternatively, some or all functions could be implemented by a state machine that has no stored program instructions, or in one or more application specific integrated circuits (ASICs), in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the subject matter of this disclosure.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is embodied herein includes:

1. A method, comprising:
by a network node device operationally coupled to a set of optical sensor devices positioned about a retail space of a retail store having a set of checkout stations positioned in the retail space, with each checkout station having at least one of a set of checkout types, each optical sensor device having an optical sensor with a field of view towards a certain region about the retail space and being operable to capture successive image data that corresponds to the certain region, with the network node device being operable to track a shopper as that shopper traverses about the retail space based on successive images captured from at least one of the set of optical sensor devices positioned about the retail space to obtain shopper track information, the network node device also being operationally coupled over a network to a wireless device associated with the tracked shopper, with the wireless device having processing circuitry operable to execute an application associated with the retail store and having a certain user account of a set of user accounts that is related to the tracked shopper,
sending a checkout request indication that includes a request to perform a checkout that utilizes a certain checkout station of the set of checkout stations that is assigned to the tracked shopper based on at least one of a shopper trust metric associated with the certain user account, a number of retail items obtained while the tracked shopper is tracked about the retail space, a set of retail item types that requires additional interaction during checkout, or the shopper track information.

2. The method of claim 1, wherein the sending step further includes:
sending, by the network node device, to the wireless device over the network, the checkout request indication so that the wireless device is enabled to output for display via the application a visual representation associated with the assigned checkout station.

3. The method of claim 1, wherein the sending step further includes:
sending, by the network node device, to an electronic display device, an indication associated with the assigned checkout station so that the electronic display device is enabled to output for display a visual representation associated with the assigned checkout station, with the electronic display device being positioned proximate the certain region of the retail space associated with the checkout at the set of checkout stations.

4. The method of claim 1, further comprising:
receiving, by the network node device, from the wireless device over the network, an indication that includes an identifier associated with the certain user account of the application and information related to a current location of the wireless device.

5. The method of claim 4, further comprising:
associating the tracked shopper with the certain user account of the application based on at least one of the certain user account identifier, the current location information, the shopper track information or the successive image data.

6. The method of claim 1, further comprising:
determining, based on the shopper track information or the successive image data, that the tracked shopper is about a certain region of the retail space associated with a checkout at the set of checkout stations.

7. The method of claim 1, further comprising:
obtaining, based on the certain user account of the application, shopper behavior information associated with the certain user account; and
determining the shopper trust metric associated with the certain user account based on the shopper behavior information.

8. The method of claim 1, further comprising:
obtaining the shopper trust metric associated with the certain user account of the application;
selecting at least one of the set of checkout types based on the shopper trust metric to obtain a selected checkout type;
assigning at least one of the set of checkout stations that correspond to the selected checkout type to obtain the assigned checkout station; and
determining to send a request to perform a checkout that utilizes the assigned checkout station.

9. The method of claim 1, further comprising:
determining a number of the obtained retail items obtained while the tracked shopper traverses about the retail space based on the shopper track information or the successive image data;
selecting at least one of the set of checkout types based on the shopper trust metric and the number of the obtained retail items to obtain a selected checkout type;
assigning at least one of the set of checkout stations that correspond to the selected checkout type to obtain the assigned checkout station; and
determining to send a request to perform a checkout that utilizes the assigned checkout station.

10. The method of claim 1, further comprising:
determining that at least one of the obtained retail items corresponds to at least one of the set of retail item types that requires additional interaction during checkout;
selecting at least one of the set of checkout types based on the shopper trust metric and the at least one of the set of retail item types that requires additional interaction during checkout;
assigning at least one of the set of checkout stations that correspond to the selected checkout type to obtain the assigned checkout station; and
determining to send a request to perform a checkout that utilizes the assigned checkout station.

11. A network node device, comprising:
with the network node device being operationally coupled to a set of optical sensor devices positioned about a retail space of a retail store having a set of checkout stations positioned in the retail space, with each checkout station having at least one of a set of checkout types, each optical sensor device having an optical sensor with a field of view towards a certain region about the retail space and being operable to capture successive image data that corresponds to the certain region, with the network node device being operable to track a shopper as that shopper traverses about the retail space based on successive images captured from at least one of the set of optical sensor devices positioned about the retail space to obtain shopper track information, the network node device also being operationally coupled over a network to a wireless device associated with the tracked shopper, with the wireless device having processing circuitry operable to execute an application associated with the retail store and having a certain user account of a set of user accounts that is related to the tracked shopper; and
wherein the network node device includes a processing circuitry and a memory, the memory containing instructions executable by the processing circuitry whereby the processing circuitry is configured to:
send a checkout request indication that includes a request to perform a checkout that utilizes a certain checkout station of the set of checkout stations that is assigned to the tracked shopper based on at least one of a shopper trust metric associated with the certain user account, a number of retail items obtained while the tracked shopper is tracked about the retail space, a set of retail item types that requires additional interaction during checkout, or the shopper track information.

12. The network node device of claim 11, wherein the memory contains instructions executable by the processing circuitry whereby the processing circuitry is further configured to:
send the checkout request indication to the wireless device so that the wireless device is enabled to output for display via the application a visual representation associated with the assigned checkout station.

13. The network node device of claim 11, wherein the memory contains instructions executable by the processing circuitry whereby the processing circuitry is further configured to:
send the checkout request indication to an electronic display device so that the electronic display device is enabled to output for display a visual representation associated with the assigned checkout station, the electronic display device being positioned proximate the certain region of the retail space associated with the checkout at the set of checkout stations.

14. The network node device of claim 11, wherein the memory contains instructions executable by the processing circuitry whereby the processing circuitry is further configured to:
receive, from each of the set of optical sensor devices, the successive image data.

15. The network node device of claim 11, wherein the memory contains instructions executable by the processing circuitry whereby the processing circuitry is further configured to:
track the tracked shopper while the shopper traverses the retail space based on the successive image data to obtain the shopper track information.

16. The network node device of claim 11, wherein the memory contains instructions executable by the processing circuitry whereby the processing circuitry is further configured to:
receive, from the wireless device, an indication that includes an identifier associated with the certain user account of the application and information related to a current location of the wireless device.

17. The network node device of claim 11, wherein the memory contains instructions executable by the processing circuitry whereby the processing circuitry is further configured to:
obtain the shopper trust metric associated with the certain user account of the application;
select at least one of the set of checkout types based on the shopper trust metric to obtain a selected checkout type;
assign at least one of the set of checkout stations that correspond to the selected checkout type to obtain the assigned checkout station; and
determine to send a request to perform a checkout that utilizes the assigned checkout station.

18. The network node device of claim 11, wherein the memory contains instructions executable by the processing circuitry whereby the processing circuitry is further configured to:
determine a number of the obtained retail items obtained while the tracked shopper traverses about the retail space based on at least one of the shopper track information or the successive image data;
select at least one of the set of checkout types based on the shopper trust metric and the number of the obtained retail items to obtain a selected checkout type;
assign at least one of the set of checkout stations that correspond to the selected checkout type to obtain the assigned checkout station; and
determine to send a request to perform a checkout that utilizes the assigned checkout station.

19. The network node device of claim 11, wherein the memory contains instructions executable by the processing circuitry whereby the processing circuitry is further configured to:
determine that at least one of the obtained retail items corresponds to a set of retail item types that requires additional interaction during checkout;
select at least one of the set of checkout types based on the shopper trust metric and the set of retail item types that requires additional interaction during checkout to obtain a selected checkout type;
assign at least one of the set of checkout stations that correspond to the selected checkout type to obtain the assigned checkout station; and
determine to send a request to perform a checkout that utilizes the assigned checkout station.

20. A system, comprising:
a set of checkout stations positioned in a retail space of a retail store, each checkout station having at least one of a set of checkout types;
a set of optical sensor devices positioned about the retail space, each optical sensor device having an optical sensor with a field of view toward a certain region of the retail space and being operable to capture successive image data that corresponds to the certain region; and
a network node device operably coupled to the set of optical sensor devices, the network node device including processing circuitry and a memory, the memory containing instructions executable by the processing circuitry whereby the processing circuitry is configured to:
track a shopper as the shopper traverses the retail space based on successive images captured from at least one of the set of optical sensor devices to obtain shopper track information; and
send a checkout request indication that includes a request to perform a checkout that utilizes a certain checkout station of the set of checkout stations that is assigned to the tracked shopper based on at least one of a shopper trust metric associated with a certain user account related to the shopper, a number of retail items obtained while the shopper is tracked about the retail space, a set of retail item types that requires additional interaction during checkout, or the shopper track information.
